(19) United States
(12) Patent Application Publication
(10) Pub. No.: US 2012/0326052 A1
(43) Pub. Date: Dec. 27, 2012

(54) SIMULTANEOUS FLUORESCENCE CORRELATION SPECTROSCOPY (SFCS)

(76) Inventor: Rudolf Grosskopf, Konigsbronn (DE)

(21) Appl. No.: 13/251,703

(22) Filed: Oct. 3, 2011

(30) Foreign Application Priority Data
Oct. 21, 2010 (DE) 102010049212.4-52

(51) Int. Cl. G01J 3/443

(52) U.S. Cl. 250/458.1; 250/216

(57) ABSTRACT

A fluorescence correlation spectroscopy apparatus for examining a specimen including an illumination grid which includes comprises light-emitting regions for illuminating the specimen; an objective arrangement that images the illumination grid into a focal plane at the location of the specimen; and a receiving grid on a receiver side, wherein after the focal plane, each orifice of the orifice plate of the observation beam path has associated with it a device for spectral dispersion of the light that has returned from the specimen; and at least two radiation receivers are associated with each device for spectral dispersion.

### TECHNICAL FIELD

The present invention relates to an apparatus for investigating a specimen using fluorescence correlation spectroscopy.

### BACKGROUND AND SUMMARY

In confocal microscopy, the specimen is illuminated (in a manner known per se) through a pinhole, and the illuminated spot on the specimen is observed with a radiation receiver whose light-sensitive area is as small as that of the illumination spot generated by the illumination pinhole (Minsky, M., U.S. Pat. No. 3,013,467, and Minsky, M., “Memoir on inventing the confocal scanning microscope,” Scanning 10, pp. 128-138). Confocal microscopy has the advantage, as compared with conventional microscopy, that it supplies depth resolution (measurement in the Z coordinate), and that little flare occurs in the context of image acquisition. Only that plane of the specimen which is in focus is brightly illuminated. Specimen planes above and below the focal plane receive much less light.

The confocal principle has been used for some time in order, for example, to observe chemical reactions of molecules at a single location in the sample. The principle applied for this is called “fluorescence correlation spectroscopy” (FCS). With this, chemical reactions between molecules in biological specimens can be observed individually. The method has already for some years offered a capability for gaining valuable knowledge in chemistry, biology, and medicine, for example for the diagnosis of illnesses and in order to assess the effectiveness of chemical substances and medications,. Well-known companies have developed high- performance research instruments for this purpose. These instruments are very flexible in terms of application, e.g. for many different light wavelengths and measurement parameters. This unfortunately also means that they are decidedly expensive to manufacture and are therefore, for economic reasons, quite unsuitable for extensive use. In addition, measurement occurs at only one location in the sample simultaneously, although chemical and/or biochemical events worthy of investigation take place in the specimen simultaneously at a great many locations.

It is therefore an object of the invention to describe a method and an arrangement that enable confocal fluorescence correlation spectroscopy to be carried out simultaneously at many locations, and enables the instruments necessary therefor to be manufactured economically.

The document DE 199 18 689 describes a device that contains an illumination grid (120b) which comprises light-emitting regions (121) and illuminates the specimen (14), and that is equipped with an objective arrangement (13u) that images the illumination grid (120b) into a focal plane (14s) at the location of the specimen (14), and with a receiving grid (17) having in front of it an orifice plate (121), and with orifices that are impinged upon through the orifice plate (121) by the objective arrangement (13u). Each light-emitting region (121) of the illumination grid (120b) impinges there upon at least two adjacent light-sensitive regions of the receiving grid (17), and the illumination grid (120b) is embodied as an illumination-side orifice plate (120) impinged upon by an illumination device (11, 11k, 11f), outcoupling of the specimen light to the receiving grid (17) occurring by means of a beam splitter cube (20), and the receiver-side (121) and illumination-side (120) orifice plates being embodied on the beam splitter cube (20) and forming a single compact assembly together therewith.

It is also known to enable the simultaneous detection of two fluorescence signals by combining two avalanche photodetectors (APDs). The ConfoCor 3 of the Carl Zeiss company has this property. It allows the analysis of two interacting partners that are labeled with differently fluorescing dyes. In this arrangement, the APD pair then receives a triple signal: from both free ligands, and from the ligand complex. The double-labeled complex thus emits an autonomous fluorescence signal that reaches both APDs, in contrast to the conventional FCS method having one fluorescing bonding partner. Only a single site in the specimen is observed at a specific point in time, however.

The object of the present invention is to indicate a way in which, using available APD arrays, fluorescence correlation spectroscopy can be carried out simultaneously at multiple locations in the sample (sFCS).

The invention provides that after the focal plane, each orifice of the orifice plate of the observation beam path has associated with it a device 302a for spectral dispersion of the light that has returned from the sample; and that at least two radiation receivers 305a are associated with each device 302a for spectral dispersion.

The invention further provides that, for simultaneous investigation of the same type of molecules at different locations in the sample, devices 302a for spectral dispersion of light are set to identical light wavelengths.

For simultaneous investigation of different types of molecules in the same specimen, the invention provides that devices 302a for spectral dispersion of light be set to different light wavelengths.

### BRIEF DESCRIPTION OF THE DRAWINGS

The Figures show examples of possible practical embodiments of the invention.

FIG. 1 shows an overall arrangement of an image acquisition device according to the invention.

FIG. 2 shows a beam splitter cube, and an example of the device for spectral dispersion of light, that are used according to the present invention.

FIG. 3 shows the beam splitter cube and the assemblies, associated according to the present invention, for spectral dispersion of light individually for many different locations in the sample simultaneously.

FIGS. 4a to 4d show examples of how the assemblies for spectral dispersion of light can be configured according to the present invention when an APD array having 36 receiver diodes is used.

### DETAILED DESCRIPTION

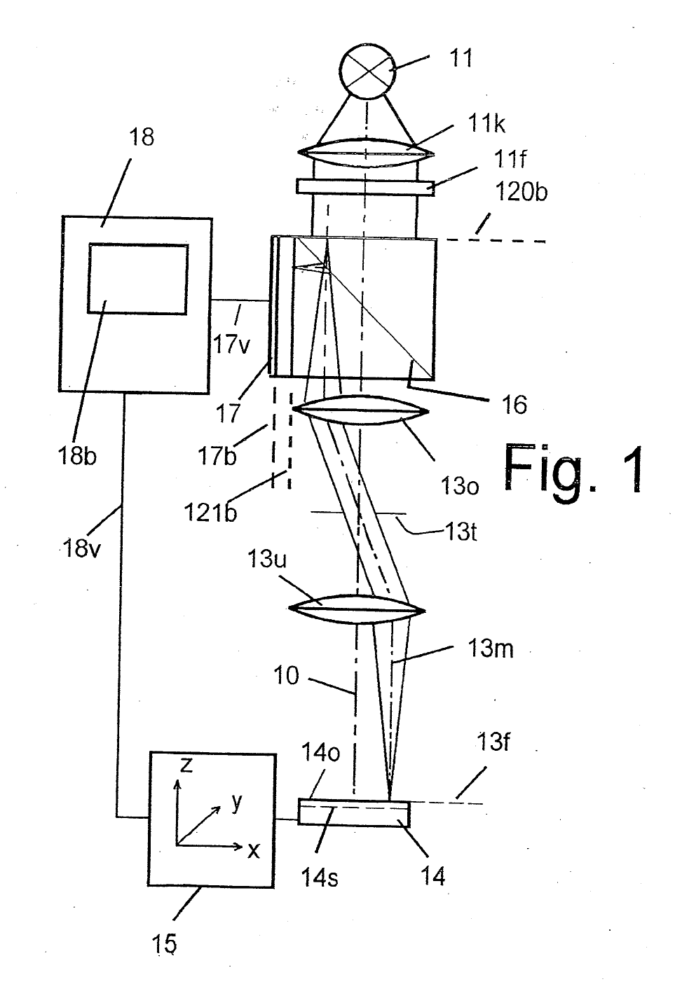

In FIG. 1, the number 11 designates a light source, e.g. a halogen lamp, that, with the aid of condenser 11k, illuminates orifices in a layer. A layer of this kind can be produced in known fashion, e.g. from chromium on a glass plate 12g. The orifices are arranged in grid fashion in the layer. Layer 18 contains, for example, orifices having an orifice size of, for example 4 μm×4 μm. The orifices are thus considerably smaller than their spacing. The illumination grid pattern generated by the illuminated orifices in the layer is located in illumination plane 120b. The latter is imaged by lenses 13o, 13u into focal plane 13f so that in the latter, specimen 14 is illuminated with spots of light arranged in a grid pattern.

In the case of non-transparent specimens, only the surface 14o can be illuminated, whereas with transparent specimens, layers 14s in the interior can also be illuminated with the spots of light. The light beams reflected from the specimen into focal plane 13f are focused by lenses 13u, 13o via beam splitter 16 into pinhole plane 121b.

For fluorescence applications, the aforesaid beam splitter 16 is embodied in a manner known per se as a dichroic mirror.

Specimen 14 can be moved by a displacement apparatus 15 in all three spatial directions, so that different layers 14s of specimen 14 can be investigated.

A receiving grid 17 serves to receive the light signals coming from the sample. The manner in which it is to be configured according to the present invention is evident from the illustrations that follow.

The signals of receiving grid 17 are transferred via connecting lead 17v into a computer 18 that, in known fashion, performs an evaluation and reproduces the results of the evaluation, for example in the form of graphic depictions, on a screen 18b. Computer 18 can also, via connecting lead 18v, control the shifting of focal plane 13f in the specimen, and scanning in the X and Y directions. This control action can exist in the computer as a permanent program, or can occur as function of the results of the evaluation.

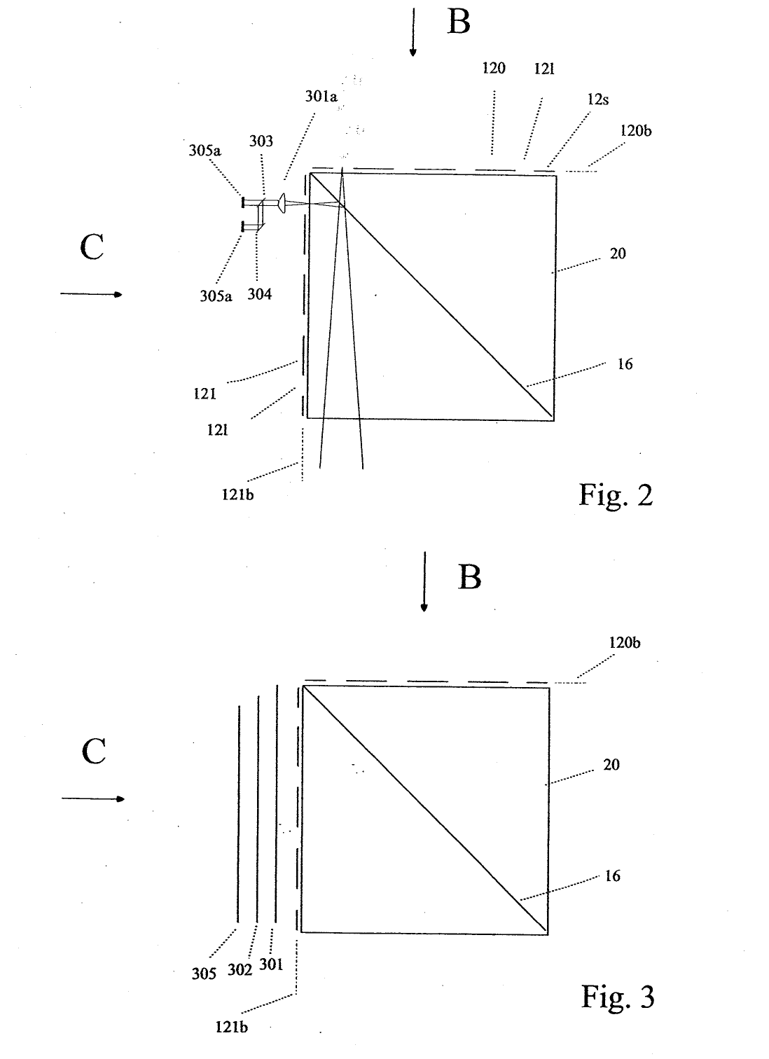

FIG. 2 shows a beam splitter cube 20 having an orifice plate 120 having orifices 120l in the illumination grid pattern in plane 120b, and a beam splitter 16. Located in plane 120b is the illumination-side orifice plate 120 having light-emitting regions 12s. Illuminating light from direction B is directed to the sample, and the light returning from the sample is directed via beam splitter 16 to receiver-side orifice plate 121, which is located on the beam splitter cube in plane 121b and is embodied similarly to illumination-side orifice plate 120. According to the present invention, the light from each of the illuminated locations in the sample strikes a collector lens 301 associated therewith. The purpose of the collector lenses is to convert the light incident onto them into an approximately parallel ray bundle that is then spectrally dispersed by the downstream micro-assembly and delivered to APD receivers 305a. In this example, the micro-assemblies are made up of a dichroic filter 303 and a fully reflective mirror 304.

FIG. 3 shows the beam splitter cube and (schematically) the assemblies associated according to the present invention for spectral dispersion of light and for radiation reception. On the receiver side, the aforementioned receiver-side orifice plate is located in plane 121b; this is then followed by collector lens array 301, array 302 for individual light dispersion, and APD array 305.

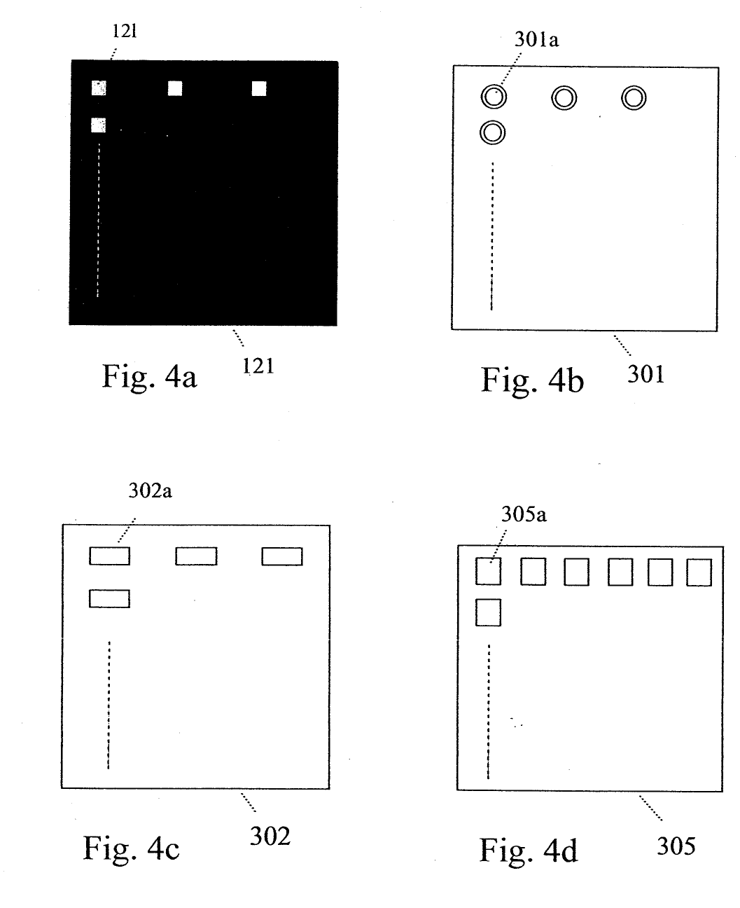

FIGS. 4a to 4d show examples of how the assemblies for spectral dispersion of light can be configured according to the present invention when an APD array having 36 receiver diodes is used. FIG. 4a illustrates the locations of orifices 121 in receiver-side orifice plate 121, FIG. 4b the locations of collector lenses 301a in collector lens array 301, FIG. 4c the locations of the micro-assemblies for spectral dispersion of light from the sample, and FIG. 4d the locations of APD receivers 305a in APD array 305.

What is claimed is:

1. A fluorescence correlation spectroscopy apparatus for examining a specimen, said apparatus comprising:
an illumination grid which includes comprises light-emitting regions for illuminating the specimen;
an objective arrangement that images the illumination grid into a focal plane at the location of the specimen; and
a receiving grid on a receiver side,
wherein after the focal plane, each orifice of the orifice plate of the observation beam path has associated with it a device for spectral dispersion of the light that has returned from the specimen; and at least two radiation receivers are associated with each device for spectral dispersion.

2. The apparatus of claim 1, wherein the devices for spectral dispersion of light are each made up of at least one dichroic mirror and one fully reflective mirror.

3. The apparatus of claim 2, wherein the devices for spectral dispersion of light are set to identical light wavelengths.

4. The apparatus of claim 2, wherein the devices for spectral dispersion of light are set to different light wavelengths.

5. The apparatus of claims 2, wherein at least one each device for spectral dispersion of light has placed in front of it a collecting lens that is located between the orifice on the receiver side and the device for spectral dispersion of light.

6. The apparatus of claim 2, wherein the light leaving the dichroic mirror in one direction is incident onto one of the radiation receivers; and the light leaving the dichroic mirror in the other direction is incident, via a fully reflective mirror, onto the other of the radiation receivers.

7. The apparatus of claim 2, wherein adjacent avalanche photodiodes of an avalanche photodiode array are used as radiation receivers, the light that is allowed to pass unreflected through the dichroic mirror being incident onto one of the avalanche photodiode receivers; and
the light that is reflected from the dichroic mirror is directed via a fully reflective mirror to another avalanche photodiode receiver.

8. The apparatus of claim 2, wherein the light that is reflected from the dichroic mirror is conveyed to a second dichroic mirror; and the light reflected from the latter is directed to the second radiation receiver; and the light allowed to pass by the second dichroic mirror is directed via a fully reflective mirror to a third radiation receiver.
